(19) United States
(12) Patent Application Publication
(10) Pub. No.: US 2015/0272245 A1
(43) Pub. Date: Oct. 1, 2015

(54) POLYMERIC GLOVE HAVING VARIED THICKNESS

(71) Applicant: Ansell Limited, Richmond (AU)

(72) Inventors: Albert Khor, Selangor (MY); Thi Hao Pham, Selangor (MY); David Lucas, Melaka (MY); Khadzrul Ariff Mohamad Baki, Selangor (MY); Mohammad Shahdan Bin Abd Latif, Melaka (MY)

(21) Appl. No.: 14/665,587

(22) Filed: Mar. 23, 2015

Related U.S. Application Data
(60) Provisional application No. 61/969,999, filed on Mar. 25, 2014.

(51) Int. Cl. A41D 31/00; A41D 13/08; B29D 99/00; B29C 41/46; B29C 71/00; A41D 19/00; B29C 41/32

(52) U.S. Cl. CPC A41D 31/0016; A41D 19/0058; A41D 13/081; A41D 13/08; A41D 13/087; B29C 41/32; B29C 41/46; B29C 71/0009; B29D 99/0067; B29D 99/0064; B29C 2071/0045; B29K 2105/04

(57) ABSTRACT

Polymeric articles having an outer polymeric layer of a non-foamed polymeric composition, an inner foamed layer of a foamed second polymeric composition disposed on the outer polymeric layer, wherein the outer polymeric layer is thicker than the inner foamed layer, and methods for manufacturing the polymeric articles, are disclosed.

### CROSS-REFERENCE TO RELATED APPLICATION

This application claims the benefit U.S. Provisional Appl. No. 61/969,999, filed Mar. 25, 2014, the entirety of which is herein incorporated by reference.

### BACKGROUND

1. Field of the Invention

Embodiments of the present invention generally relate to polymeric barrier articles. More specifically, embodiments of the invention relate to flexible, dexterous polymeric gloves having varied thicknesses in different zones of the gloves.

2. Description of the Related Art

Gloves, and other protective articles, are used in many industries. Notably, the medical industry uses thin, flexible gloves to protect the hands of medical personnel, i.e., surgical gloves for surgeons as well as examination gloves for various functions. While protection against germs, viruses, and microbes is paramount, it is further important that gloves have high resistance to tears while remaining flexible so that intricate procedures, in which scalpels, forceps, hemostats, and the like are used, can be performed. However, many gloves are relatively weak and are susceptible to breach during use and particularly extended use, increasing the risk of transmission of germs, etc., from doctor to patient and vice versa. Moreover, although tight-fitting gloves are desirable for dexterity, tight fitting gloves lead to perspiration within the gloves, which is not hygienic and causes a clammy, loose feeling, which in turn causes a loss of dexterity, particularly during longer procedures.

For safety reasons, medical personnel often double-glove, although this also leads to a loss in dexterity and does not solve the perspiration problem. Furthermore, hands tire more quickly when personnel double-glove. Flock-lined gloves absorb moisture. However, flock-lined gloves are not suitable for medical uses because of the tendency of the gloves to shed the flock. Elastomeric layers disposed on gloves are sometimes foamed, which can alleviate the clammy feeling, although many such gloves are susceptible to tearing. Other foamed gloves, such as polyurethane gloves, may be strong but contain volatile organic compounds, which can be skin irritants or are otherwise harmful. Gloves that have laminated perspiration-managing layers are impractically thick and/or expensive to produce.

A foamed polymeric glove, having acceptable tensile and tear properties while remaining thin, soft, flexible and moisture-absorbent, represents an advance in the art.

### SUMMARY

Polymeric gloves, including foamed polymeric gloves, having varied thicknesses in different zones of a glove, substantially as shown in and/or described in connection with at least one of the figures, as set forth more completely in the claims, are disclosed. Various advantages, aspects, and novel features of the present disclosure will be more fully understood from the following description and drawings.

The foregoing summary is not intended, and should not be contemplated, to describe each embodiment or every implementation of the present invention. The Detailed Description and exemplary embodiments therein more particularly exemplify the present invention.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings and disclosure depict exemplary embodiments of the invention and are therefore not to be considered limiting of the scope of the particular forms described, for those skilled in the art will recognize additional embodiments of the present invention, which covers all modifications, equivalents, and alternatives within the spirit and scope of the present invention as defined by the appended claims.

FIG. 1 depicts a glove, palm side up, comprising an outer polymeric layer and an inner foamed polymeric layer, according to embodiments of the present invention;

FIG. 2 depicts a cross-section view taken along line 2-2 of a palm area of the glove of FIG. 1, according to embodiments of the present invention;

FIG. 3 depicts a cross-section view taken along line 3-3 of an index finger of the glove of FIG. 1, according to embodiments of the present invention;

FIG. 4 depicts a perspective view of the cross section of FIG. 2, according to embodiments of the present invention;

FIG. 5 depicts a perspective view of the cross section of FIG. 3, according to embodiments of the present invention;

FIG. 6 depicts an exemplary flow diagram for a method for producing a polymeric article, according to embodiments of the invention;

FIG. 7 depicts an exemplary flow diagram for a method for producing an article having a foamed layer and a non-foamed layer, according to embodiments of the invention; and

FIG. 8 depicts a diagram for a method and apparatus for producing a glove comprising an unfoamed polymeric layer and foamed polymeric layer disposed on the unfoamed polymeric layer, according to embodiments of the invention.

The headings used herein are for organizational purposes only and are not meant to be used to limit the scope of the description or embodiments according to the invention. As used throughout this application, the word “may” is used in a permissive sense, meaning having the potential to, rather than the mandatory sense. Similarly, the words “include,” “including,” and “includes” mean including, but not limited to.

### DETAILED DESCRIPTION

Embodiments according to the present invention include protective barriers that comprise one or more foamed polymeric layers and/or one or more non-foamed polymeric layers, such as surgical and/or examination gloves, having a varied thickness in regions (tips of fingers, entire finger, lower palm, upper palm, cuff, etc.) of the gloves. Methods for manufacturing the gloves are also disclosed. Finger cots, sleeves, and condoms, among other protective barrier articles, are also considered within the scope of embodiments of the invention.

Many rubber compositions are suitable for use with the present invention, including nitrile butadiene, carboxylated nitrile butadiene, polyisoprene, polychloroprene, polyurethane, styrenic block copolymers, and the like, and blends thereof. The compositions comprise accelerators, such as dithiocarbamates, thiazoles, or thioureas. In some embodiments, the accelerator comprises at least one of zinc dibutyl dithiocarbamate (ZDBC), zinc 2-mercaptobenzothiazole (ZMBT), N—N′-diphenylthiourea (DPTU), zinc diethyl dithiocarbamate (ZDEC), or sodium dibutyl dithiocarbamate (SDBC), while in other embodiments, a combination of two or more accelerators are used. A non-exhaustive list of exemplary compositions, according to embodiments of the invention are shown in Table 1, as discussed below.

Composition C from Table 1, which is free of the accelerator diphenyl guanidine (DPG) and comprises polysulphidic sulphur donors, such as dipentamethylene thiuram tetrasulphide (DPTT) and/or a xanthogen polysulphide, such as di-isopropyl xanthogen polysulphide, unexpectedly provides a particularly soft yet flexible rubber barrier layer. It is noted that Composition C was superior in terms of unaged tensile strength, tear strength, and elongation at break, while remaining soft and flexible, although all compositions show unexpectedly enhanced physical properties. Moreover, the softness of the layers having enhanced tensile strength, tear strength, and elongation at break properties can be attributed to the polysulphidic sulphur donor, which inter-crosslinks rubber molecules and also creates polysulphidic intra-crosslinks within the rubber network. It is further believed that the synergy of the polysulphidic sulphur donor with other accelerators produces a balance of polysulphidic, disulphic, and monosulphidic crosslinks, which provide the enhanced unaged and aged physical properties.

TABLE 1

| | Compo- | Compo- | Compo- | Compo- | Compo- |
|---|---|---|---|---|---|
| Components | sition | sition | sition | sition | sition |
| Total PHR | A | B | C | D | E |
| Polyisoprene | 100 | 50 | 50 | 50 | 50 |
| Polychloroprene | — | 50 | 50 | 50 | 50 |
| Sulfur | 1.6 | 1.6 | 1.6 | 3.2 | 1.6 |
| Flow Modifier | 0.1 | 0.1 | 0.1 | 0.4 | 0.4 |
| Activator | 0.7 | 0.7 | 0.7 | 3.0 | 3.0 |
| Antioxidant | 2.0 | 2.0 | 2.0 | 2.0 | 2.0 |
| ZDBC | 0.1 | 0.1 | 0.1 | 0.8 | 0.8 |
| ZMBT | 0.2 | 0.2 | 0.2 | — | — |
| DPG | 0.3 | 0.3 | — | — | — |
| DPTU | — | — | — | 0.8 | 0.8 |
| DPTT | — | — | 0.3 | — | — |
| ZDEC | 0.6 | 0.6 | 0.6 | — | — |
| SDBC | 0.1 | 0.1 | 0.1 | — | — |
| Xanthogen Polysulphide | 0.4 | 0.4 | 0.4 | — | — |
| Anionic stabilizer | 0.1-1.5 | 0.1-1.5 | 0.1-1.5 | 0.1-1.5 | 0.1-1.5 |
| Thixotropic agent | 0.1-3.0 | 0.1-3.0 | 0.1-3.0 | 0.1-3.0 | 0.1-3.0 |

Other additives known to those in the art may be incorporated within the above compositions. For example, stabilizers, such as sodium salts; surfactants, such as acetylenic diols, thickeners, such as polyacrylate/methacrylic acid-acrylic ester copolymer/cellulose ether and emulsions thereof; fillers; anti-microbial agents, waxes, matting agents, and pigments may be added to compositions A-E described in Table 1 as well as other compositions. Optionally, a de-foaming agent may be added to any composition that will be used for a non-foamed layer while a foaming agent may be added to any composition if it will be disposed as a foamed layer.

Moreover, exemplary embodiments of the invention comprise a polymeric composition having a viscosity in the range of approximately 1-5000 centipoises. Exemplary embodiments according to the invention further comprise compositions (such as those of Table 1) having a viscosity in the range of 1-100 centipoises and a total solids content (TSC) of 20-50%. The ingredients of compositions are compounded to prepare the compositions for disposition on a former or a fabric lining dressed on a former. For example, a polyisoprene composition, a polychloroprene composition, a sulphur dispersion and a stabilizer solution are delivered to a vessel and mixed at approximately 4-15 RPM at a temperature ranging from approximately 5-35° C. to form a mixture as is known by those having skill in the art. Thereafter, an activator, such as zinc oxide, one or more accelerators (ZDBC, ZMBT, ZDEC, or the like) DPTT (if present), and an antioxidant dispersion, are stirred into the mixture and pre-cured for approximately 20-24 hours. A dispersion of ZDEC, a dispersion of SDBC, a solution of xanthogen polysulphide, an antioxidant dispersion, a stabilizer solution, a flow modifier, and a de-foaming agent are stirred into the mixture at approximately 4-15 RPM, holding the temperature of the mixture at approximately 5-35° C. This mixture is allowed to mature for approximately 20-40 hours. Thereafter, an anionic surfactant may be added to the mixture and stirred for 5-10 minutes. A thixotropic agent is added and stirred for 1-2 hours. The mixture is optionally diluted to a desired TSC and an emulsion thickener (such as an acrylic emulsion thickener, and/or a methacrylic acid/alkyl acrylate copolymer), is added to bring the viscosity of the mixture within a desired range, as discussed below. The amount of thickener to achieve a desired viscosity varies with the thickener used. In at least one exemplary embodiment, the composition comprises 1.0-2.0 PHR of methacrylic acid/alkyl acrylate copolymer. In some embodiments according to the present invention, one or both of the non-foamed and foamed layers described herein comprise substantially (i.e., about 80% wt. or more of polymer components) of an approximately 1:1 mixture (i.e., about 4:6 to about 6:4 parts wt.) of polyisoprene and polychloroprene.

Embodiments according to the invention may also include a foamed polymeric, elastomeric, or latex composition, i.e., dispersed air cells in a range of 1 to 70 volumetric percent, forming closed cells or open cells with interconnected porosity in the coating. Methods for incorporating foamed compositions having air contents between, for example, 1-70% are described in Woodford et al., U.S. Pat. No. 7,048,884, which is commonly assigned and incorporated herein in its entirety.

In some embodiments of the invention, the composition, such as compositions A-E from Table 1, is foamed, having dispersed air cells, in a closed- or open-celled structure, in a range of approximately 5 to 70 volumetric percent. In at least one exemplary embodiment, composition C from Table 1 further comprises 0.1-1.5 PHR of an anionic stabilizer, such as sodium linear alkyl benzene sulfonate, or sodium alkyl sulfates, or straight chain carboxylates, such as potassium laurate, potassium caprylate, and the like; and 0.1-3.0 parts per hundred (PHR) of a thixotropic agent, such as sulfosuccinimates, e.g., sodium N-alkylsulphosuccinamates, disodium N-alkylsulphosuccinamates, and the like.

Exemplary embodiments of the invention comprise a foamed polymeric, elastomeric, or latex composition, having a viscosity in the range of approximately 1-300 centipoises. Some exemplary embodiments further include the compositions of Table 1 having a viscosity in the range of 5-30 centipoises before foaming. The TSC of the compositions are approximately 5-50%. In some exemplary embodiments, the TSC of a foamed composition is approximately 5-40%. After foaming, the viscosity of the compositions is approximately 30-300 centipoises. The compositions, as described above, are compounded. In at least one exemplary embodiment of the invention, composition C is compounded with 0.4-0.6 PHR of an anionic stabilizer and 1.2-1.6 PHR of a thixotropic agent, creating a composition having a TSC of 18-22%. Sulfosuccinamates are effective in providing a low viscosity at low shear rates during foaming as well as providing a stable foam at a surprisingly low TSC. The low viscosity and low TSC allows for a thin yet stable gelled foam layer, for example, 0.05-0.10 mm, which, as described below, may be disposed on a non-foamed layer of approximately the same thickness. Embodiments according to the invention include a glove, which may comprise a foamed polymeric layer on a fabric liner to form a supported glove, a fabric liner having a non-foamed polymeric layer disposed thereon, with a foamed polymeric layer disposed on the non-foamed polymeric layer, or, separately, a foamed polymeric layer on a non-foamed polymeric layer, to form an unsupported glove. All of the methods for reducing the thickness of the foamed polymeric layer may be employed in any of the above mentioned embodiments.

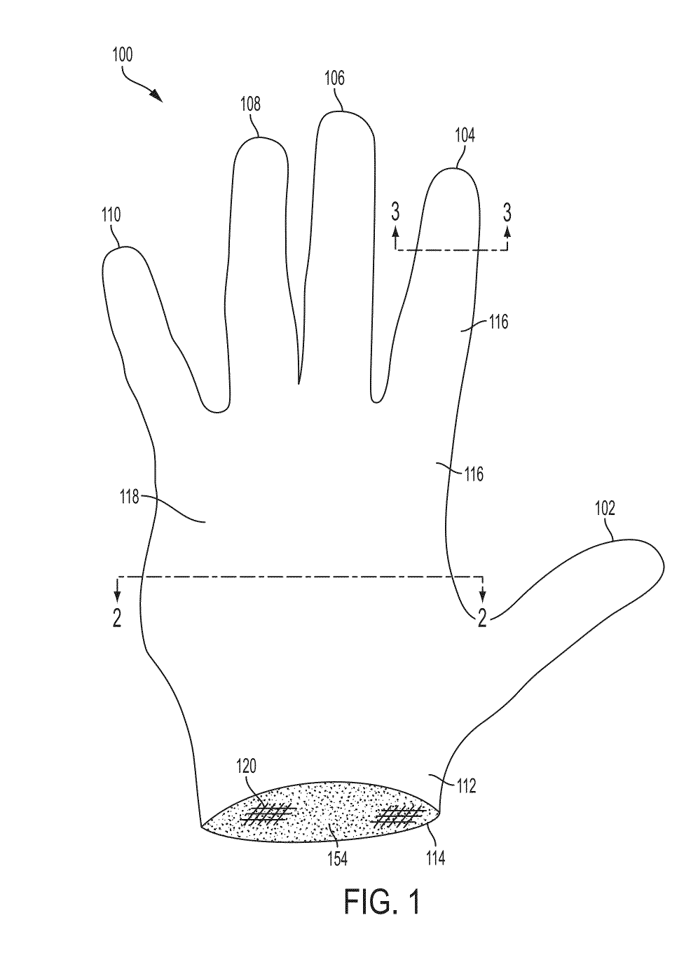

FIG. 1 depicts a glove 100, palm side up, comprising an outer polymeric layer 116 and an inner foamed polymeric layer 154, according to embodiments of the present invention. The glove 100 includes an outer polymeric layer 116 comprising, typically, a non-foamed polymeric composition, such as compositions primarily of polyisoprene and polychloroprene, as described above, and an inner foamed polymeric layer 154, disposed on the outer polymeric layer 116. The glove 100 further comprises thumb 102, fingers 104, 106, 108, and 110, palm 118, and, optionally, cuff 112 and beaded ring 114. An internal opening 120 is for receiving a hand of a user. The illustrative glove 100 has inner foamed polymeric layer 154 throughout an interior of the glove 100 and is shown on an interior of the cuff 112. However, the inner foamed polymeric layer 154 need not be disposed on all parts of the glove 100 and may be, for example, only on one or more of the thumb 102 or one or more of the fingers 104, 106, 108, and 110 or the tips numbers thereof (i.e., substantially the region of the distal phalanges), or the dorsal or palm side thereof. As further discussed below, the thickness of the glove 100 may be varied, e.g., the glove 100 is thicker where the inner foamed polymeric layer 154 is disposed on the outer polymeric layer 116 and thinner where it is not. Also, as further described below, the thickness of the inner foamed polymeric layer 154, itself, can be varied, allowing additional thickness variations to be created.

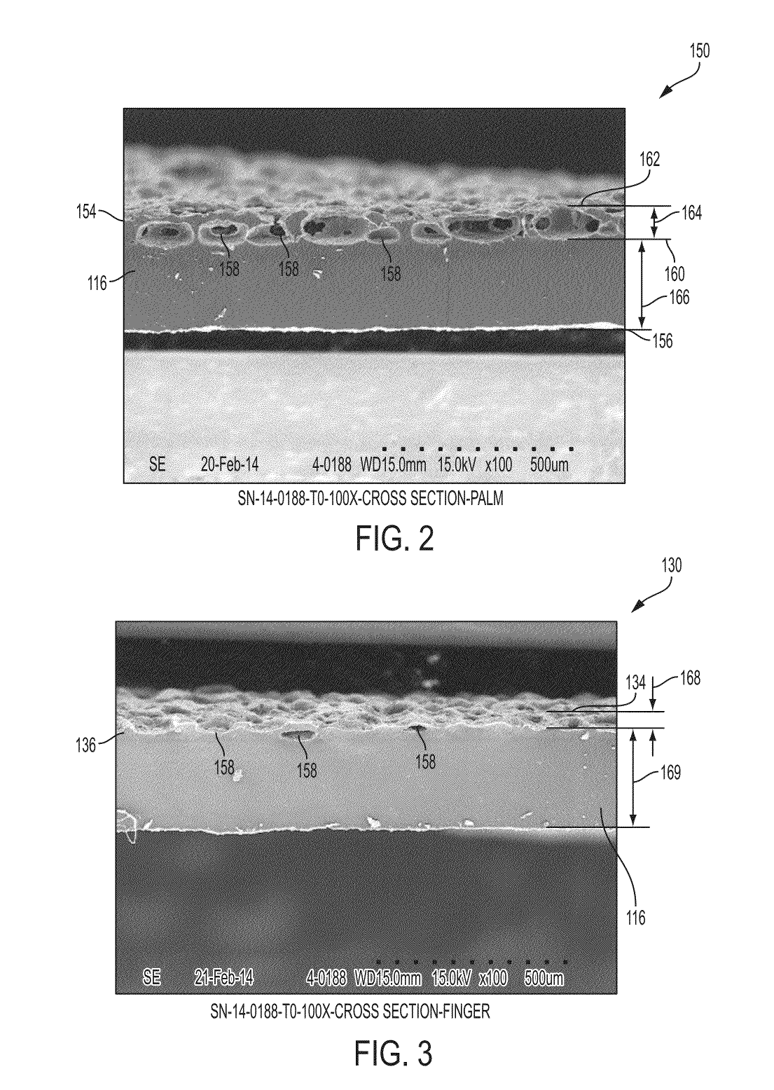

FIG. 2 depicts a cross-section view 150 taken along line 2-2 of a palm area of the glove 100 of FIG. 1, according to embodiments of the present invention. For the sake of simplicity, only the bottom portion of the cross-section 150 is shown. The cross-section view 150 comprises an outer polymeric layer 116 and an inner foamed polymeric layer 154, which is disposed on the outer polymeric layer 116. The inner foamed polymeric layer 154 comprises air cells 158. As discussed above, the inner foamed polymeric layer 154 can have a different thickness in different areas of the glove 100. In some exemplary embodiments of the invention, the glove 100 comprises the inner foamed polymeric layer 154 disposed on the palm area 118, where perspiration is most likely to form and can be absorbed by the inner foamed polymeric layer 154. In some embodiments, the inner foamed polymeric layer 154 extends from the palm area 118 to the cuff 112 while in other embodiments, the cuff 112 does not have the inner foamed polymeric layer 154 disposed thereon. In some embodiments, the inner foamed polymeric layer 154 is disposed only on one or more of the fingers 104, 106, 108, 110 and thumb 102 or only on the tips of one or more of the fingers 104, 106, 108, 110 and thumb 102.

In some embodiments of the invention, air cells comprise an open-celled structure, as shown, forming a network of inter-connected cells, facilitating moisture or oil absorption. The inner foamed polymeric layer 154 further comprises an inner surface 162, disposed on the interior of the glove 100 and contacts the skin of the user when the glove 100 is worn. Also, moisture or oil can penetrate into the inter-connected cells, so that the inner surface 162 can contact an article that is gripped while wearing the glove 100, providing enhanced grip-ability. The outer polymeric layer 116 comprises the outer surface 156, which is the exterior of the glove 100. The outer polymeric layer 116 and the inner foamed polymeric layer 154 meet at plane 160. In some embodiments of the invention, the outer polymeric layer 116 has a thickness 166 of approximately 0.08 to approximately 0.30 mm. At least one exemplary embodiment of the invention comprises the outer polymeric layer 116 having a thickness of 0.08-0.20 mm, and the inner foamed polymeric layer 154 has a thickness 164 of approximately 0.04-0.10 mm. In at least one exemplary embodiment of the present invention, the outer layer 116 has the thickness 166 of 0.10 mm and the inner foamed layer 154 has the thickness 164 of approximately 0.06 mm. Also, in embodiments of the invention, the thickness 164 of the inner foamed polymeric layer 154 is approximately 0.15 to about 0.40 the total thickness, i.e., the thickness 164 divided by the sum of the thickness 164 and the thickness 166 of the cross section 150 of the glove 100.

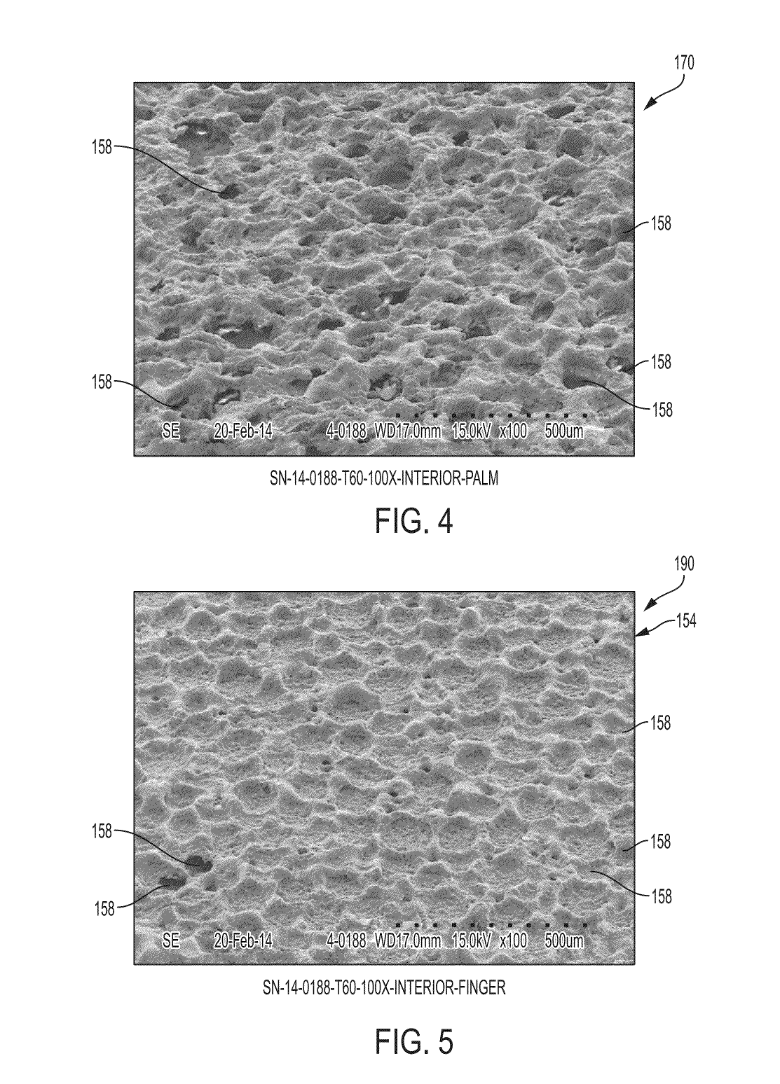

FIG. 3 depicts a cross-section view 130 taken along line 3-3 of an index finger 104 of the glove 100 of FIG. 1, according to embodiments of the present invention. For the sake of simplicity, only the bottom portion (palm side) of the cross-section 130 is shown. The cross-section 130 of the index finger 104 comprises an outer polymeric layer 116 and a second foamed layer 134, which is disposed on the outer polymeric layer 116. The second foamed layer 134 comprises air cells 158. In some embodiments, air cells comprise an open-celled structure, as shown, forming a network of inter-connected cells, which absorb moisture. Also, an outer polymeric layer 116 and the second foamed layer 134 meet at plane 136. In some embodiments of the invention, the outer polymeric layer 116 has a thickness 169 of approximately 0.08 mm to approximately 0.30 mm and in some embodiments, 0.08-0.20 mm. The second foamed layer 134 has a thickness 168 of approximately 0.03 mm to approximately 0.10 mm and in at least one exemplary embodiment, 0.04-0.10 mm. In at least one exemplary embodiment of the present invention, the thickness 169 of the outer polymeric layer 116 is 0.10 mm and the thickness 168 of the second foamed layer 134 is approximately 0.06 mm. Also, in at least one exemplary embodiment of the invention, the thickness 168 of the second foamed layer 134 is approximately ⅛-⅓ the thickness of the total thickness, i.e., the ratio of the thickness 168 divided by the sum of the thickness 168 and the thickness 169, of the cross section 130 of the glove 100. Embodiments of the invention include at least two methods for creating a thinner second foamed layer 134, as described below. As can be seen, the foamed second layer 134 (in the index finger 104 area) is approximately one half the thickness of the inner foamed polymeric layer 154 in the palm area of FIG. 2. FIG. 3 depicts a cross-section view taken along line 3-3 of an index finger of the glove of FIG. 1, according to embodiments of the present invention. FIG. 4 depicts a perspective view 170 of the cross section of FIG. 2, according to embodiments of the present invention.

FIG. 5 depicts a perspective view 190 of the cross section of FIG. 3, according to embodiments of the present invention. The perspective view 190 is taken from a top 60° tilt at 100X power and depicts a surface morphology having air cells 158 in an interconnected open-celled structure. As discussed above, an open-celled morphology absorbs liquids, drawing, for example, sweat away from the skin of the user and into an internal matrix of the foamed layer. As can be clearly seen, much of the polymeric composition comprising the second foamed layer 154 has been removed, compared with the inner foamed layer 134 of FIG. 4. In other words, the thickness 168 in FIG. 3 is substantially less than the thickness 164 in FIG. 2.

In embodiments, the thickness at one region is about 20% to about 60% of the thickness at a comparative region on the palm, in the case of a glove, or towards the base of the penis, in the case of a condom. In glove embodiments, the thickness of a region of a palm side of a finger 104, as above, is about 0% to about 60% of the comparative thickness.

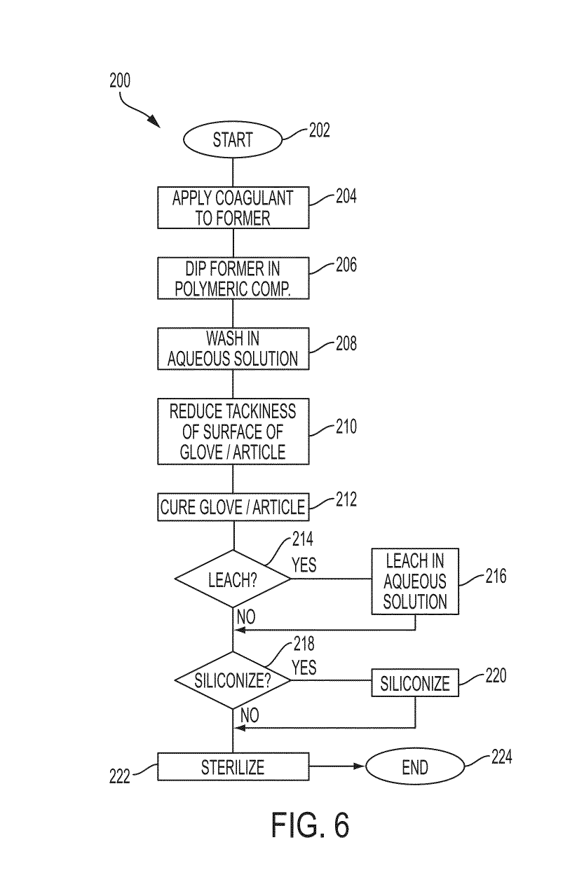

FIG. 6 depicts an exemplary flow diagram for a method 200 for producing an article according to embodiments of the invention. The article may be a protective barrier article, such as a surgical or examination glove, a glove having a fabric liner in which a polymeric layer is disposed thereon as a coating, a condom, or other typical articles comprising polymeric coatings. The method 200 begins at step 202 and proceeds to step 204, at which point a former, such as a glove-shaped former, has a coagulant applied thereto, such as a powdered coagulant or powder-free coagulant for an unsupported glove (or spraying/dipping into an aqueous or alcoholic solution (or mixture thereof) between 1.5-30% calcium nitrate or calcium citrate for a supported glove, i.e., a powder-free coagulant). Optionally, a former is heated before the application of the coagulant. In some embodiments, the former is heated to approximately 50-90° C. At step 206, the method 200 proceeds to dipping the former into a foamed or non-foamed composition, as shown in, for example, Table 1, forming a gelled (but uncured) composition layer. In some exemplary embodiments, the temperature of the composition in which the former is dipped ranges from approximately 5-35° C. At step 208 the gelled composition layer is washed, for e.g., in water, and, in some embodiments, room temperature water, such as water at a temperature between 15-30° C. In addition to removing impurities from the gelled composition layer, the washing step 208 can lessen the thickness of the gelled composition layer whether foamed or non-foamed.

The method 200 proceeds to step 210, at which point the gelled composition layer has its surface rendered less tacky, such as by chlorinating or disposing a polymer coating. At least one suitable polymer coating may include, for example, a layer of a polyurethane and a wax at a temperature of 10-35° C., approximately 2-10 microns thick, disposed on the surface of the article, by methods known to those in the art or, in some embodiments according to the invention, as in U.S. Pat. No. 7,084,204, or 6,709,725 which are commonly assigned and incorporated herein by reference in their entireties. Such layers are disposed on articles to aid in the donning and doffing of the gloves. At step 212, the gelled polymeric layer is cured. Curing is accomplished by heating the glove to an elevated temperature in, for example, any conduction, convection, or radiation oven at, for example, approximately 70-145° C. for approximately 30 to 90 minutes. In some embodiments, the coating is cured at 120° C. for 60 minutes. Exemplary embodiments according to the invention further comprise curing in stages. For example, a first curing step includes heating the non-foamed polymeric, elastomeric, or latex coating and the foamed coating at 50-90° C. for 5-10 minutes and a second curing step includes heating the non-foamed polymeric, elastomeric, or latex coating and the foamed coating at 90-160° C. for 20 to 90 minutes.

The method 200 next proceeds to step 214, at which point a decision is made whether to leach the article, e.g., a glove, a second time. If the answer is yes, the article is leached at step 216, stripped from the former, and washed in hot water. If the answer is no, the method 200 proceeds directly to step 218, at which point the decision is made whether to siliconize the article. If the answer is yes, the article is siliconized and dried at step 220. Articles may be siliconized by methods known to those in the art or, in some embodiments according to the invention, as in Ser. No. 14/107,420, which is commonly assigned and incorporated herein by reference in its entirety.

The method 200 proceeds to step 222, if the answer to step 218 is no, whereupon the article, whether siliconized or not, is sterilized. Sterilization can be accomplished by, for example, at least one of electron-beam radiation or gamma radiation. The method 200 ends at step 224. It is to be noted that some steps may be omitted from the method 200. For example, the former need not be heated. Likewise, the glove need not be chlorinated. Also, additional steps may be added, for example, applying a powder as an anti-tack agent within the coagulant, which can aid in stripping and inverting the article, particularly if the article is a glove, from the former. The article may also be further processed with offline washing, drying and surface treatment.

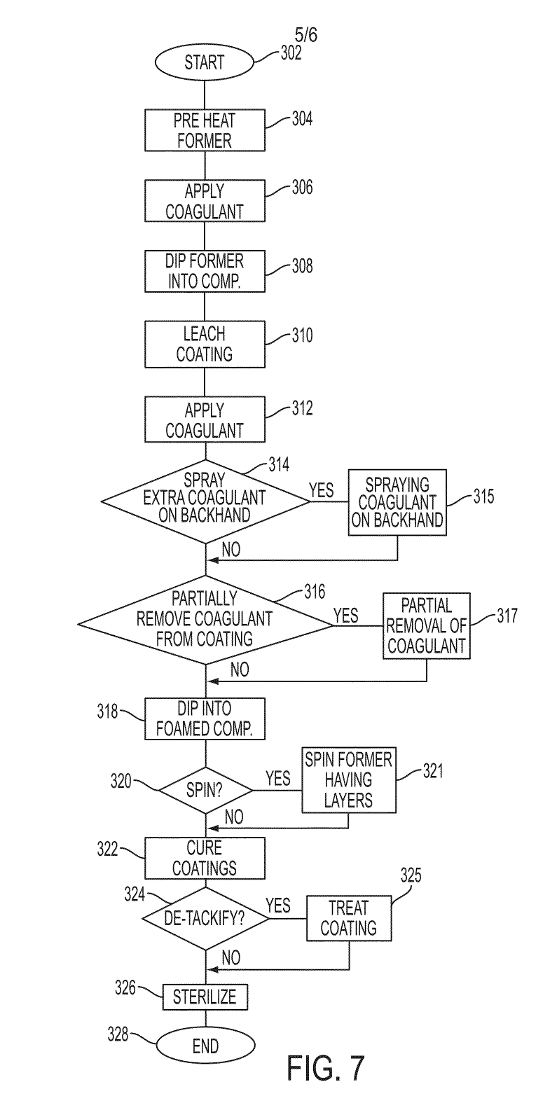

FIG. 7 depicts an exemplary flow diagram for a method 300 for producing an article having a foamed layer and a non-foamed layer, according to embodiments of the invention. The article may be a protective barrier article, such as a surgical or examination glove, or a condom and the like. Typically, the foamed layer would be on the inside of the article, although this is not required. Moreover, in practice, it may be desirable to form a non-foamed layer, then disposed a foamed layer on the non-foamed layer, and invert the article so that the foamed layer is on the inside of the article.

The method 300 begins at step 302 and proceeds to step 304, at which point a former, such as a glove-shaped former, is pre-heated, for example, to 40-100° C. At step 306, the former has a coagulant applied thereto, such as a powdered coagulant or powder-free coagulant, e.g., an aqueous or alcoholic solution between 1-30% calcium nitrate or calcium citrate or other coagulants known to those in the art. At step 308, the method 300 proceeds to dipping the former, for example, a batch dipping, into a non-foamed composition, for example, as shown in Table 1, forming a layer or coating of gelled non-foamed composition. In some exemplary embodiments, the temperature of the non-foamed composition in which the former is dipped ranges from approximately 5-35° C. At step 310, the gelled foamed layer is washed in, for e.g., water, and, in some embodiments, such as water at room temperature, to decrease the thickness of the foamed composition. Thereafter, the non-foamed composition is optionally leached in hot water, i.e., 40-90° C. to remove impurities, chemicals, proteins, and the like.

The method 300 proceeds to step 312, at which point the layer of gelled composition undergoes another coagulant dip, such as an approximately 2-15% aqueous solution of calcium nitrate. At step 314, a decision is made whether to spray additional coagulant on a backhand area. If the answer is yes, at step 315, additional coagulant is disposed or sprayed on the backhand area of the gelled foamed layer. Due to the curvature shape of the former, the palm back tends to pick-up less coagulant than the palm front. Therefore, an additional amount of coagulant applied on the backhand area compensates this difference and promotes evenness in the thickness of the foamed layers on both sides of the former.

At step 316, a decision is made whether to partially remove or lessen the amount of coagulant on the gelled layer. If the answer is yes, at step the coagulant is optionally partially washed off from, for example, the finger tips and thumb tip. Washing the fingertips and thumb tip removes some of the coagulant. In other words, the concentration of the coagulant already disposed on the former is reduced, resulting in a reduction of the amount of the composition that is destabilized by the coagulant and therefore producing a thinner second gelled layer, as is described below.

At step 318, the former having the layer of gelled composition is dipped a second time into a foamed composition, such as a composition A-E (further including an anionic stabilizer and thixotropic agent, as discussed above) from Table 1, forming a second gelled layer, disposed on top of the first gelled layer. As discussed above, the second gelled layer may also be thinned by a washing step 319, similar to step 310, although this step is optional. At step 320, the decision is made whether to spin the former having the first gelled layer and second gelled layer. If yes, at step 319, the former is spun to allow the first and second layers to smooth out. The former may be spun at, for example, 2-20 RPM. Also, optionally, the first and second gelled layers may be beaded, i.e., roll the cuff area into a ring-roll for ease of donning and doffing in use.

At step 322, the gelled polymeric layers are cured. Curing is accomplished by heating the former having the first and second gelled layers to an elevated temperature in, for example, any conduction, convection, or radiation oven in two stages. For example, the former having the first and second gelled layers is first heated for approximately 5-10 minutes at approximately 50-90° C. Next, the former and the first and second gelled layers are heated at a second, higher temperature, for approximately 20 to 90 minutes at, for example, 90-160° C.

At step 324, the decision is made whether to render the surface of the glove less tacky by a treatment, such as by chlorinating the glove or by the disposition of a polymer coating at step 325. The polymer coating may include, for example, a layer of a polyurethane and a wax at a temperature of 10-35° C., approximately 2-10 microns thick, disposed on the surface of the article, by methods known to those in the art or, in some embodiments according to the invention, as in U.S. Pat. No. 7,084,204, or 6,709,725 which are commonly assigned and incorporated herein by reference in their entireties. Such layers are disposed on articles to aid in the donning and doffing of the gloves. Alternatively, the article may be siliconized. Articles may be siliconized by methods known to those in the art or, in some embodiments according to the invention, as in Ser. No. 14/107,420, which is commonly assigned and incorporated herein by reference in its entirety.

The method 300 proceeds to step 326, whereupon the article is sterilized. Sterilization can be accomplished by, for example, at least one of electron-beam radiation or gamma radiation. The method 300 ends at step 328. It is to be noted that some steps may be omitted from the method 300. For example, the former need not be pre-heated. Likewise, the glove need not be chlorinated. Also, additional steps may be added, for example, applying a powder as an anti-tack agent within the coagulant, which can aid in stripping and inverting the article (which places the foam layer on the interior where it can absorb moisture), particularly if the article is a glove, from the former. The article may also be further processed with offline washing, drying and additional surface treatments.

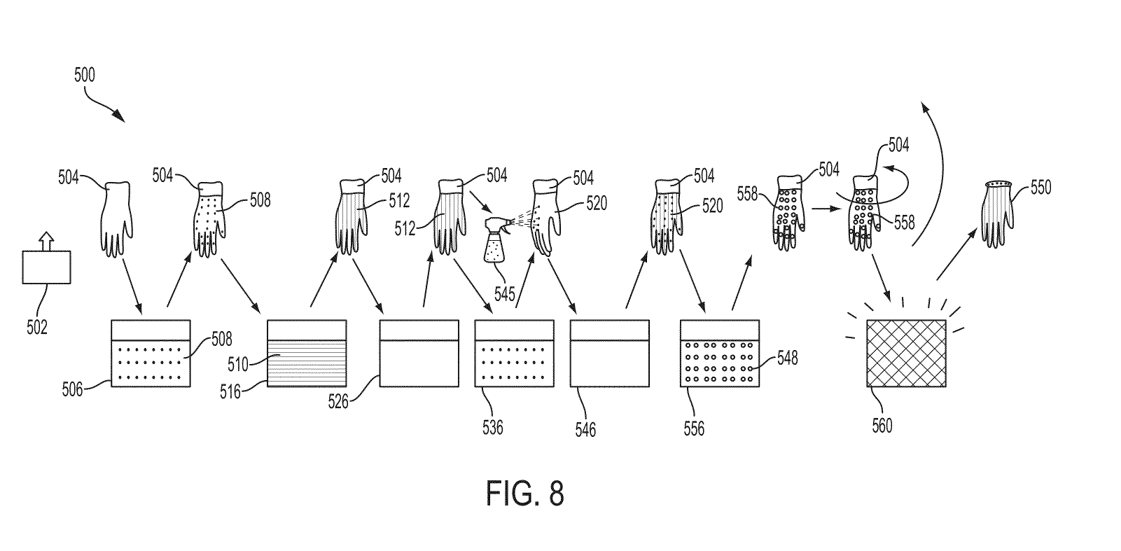

FIG. 8 depicts a diagram for a method and apparatus 500 for producing a glove comprising an unfoamed polymeric layer and foamed polymeric layer disposed on the unfoamed polymeric layer, according to embodiments of the invention. The apparatus 500 comprises a controller 502, which controls, for example, production line equipment, such as electronic circuits for controlling robots that deliver glove formers 504 to tanks 506, 516, 526, 536, 546, 556, and an oven 560. A former 504 is provided. The former 504 is dipped into a tank 506 containing a coagulant 508, such as the aqueous or alcoholic (or aqueous/alcoholic mixture) coagulant as described herein, which becomes disposed on the former 504. Embodiments of the invention also comprise a knitted fabric liner (not shown) dressed on the former 504. The former 504 is optionally heated, for example, pre-heated to approximately 50-70° C., before dipping into the coagulant tank 506. In either case, pre-heated or unheated, the former 504 having the coagulant 508 disposed is removed from the coagulant tank 506 and allowed to dry. Some embodiments of the invention comprise removing some of the coagulant using a dipping step into water (as discussed further below), which may be used, for example, to limit the amount of polymeric composition (discussed below) disposed on the former 504 in subsequent steps.

The former 504 having the coagulant 508 disposed thereon is then dipped into a tank 516, containing an unfoamed polymeric composition 510 and is removed therefrom. The former 504 now has an uncured unfoamed polymeric composition disposed as an uncured and unfoamed polymeric layer 512 thereon and is optionally delivered to a tank 526 containing water, for example, hot water, in which the uncured and unfoamed polymeric layer 512 is leached of impurities and/or proteins. The hot water bath may also remove part of the uncured unfoamed composition 510, promoting adherence of subsequently disposed polymeric compositions as well as reducing the thickness of the uncured and unfoamed polymeric layer 512 disposed on the former 504.

The former 504 having the uncured and unfoamed polymeric layer 512 disposed thereon is then delivered to a coagulant tank 536, which may contain the same coagulant within tank 506 or contain a different coagulant, such as a weaker acid, for example, a formic acid or acetic acid solution, in which the uncured unfoamed polymeric layer 512 is dipped. The unfoamed polymeric composition 510, which is an uncured layer on the former 504, now has a coagulant coating 520 thereon. Subsequently, the former 504 having coagulant coating 520 is optionally sprayed with a coagulant within tank 506 or a different coagulant on a backhand area of the unfoamed polymeric composition 510. As before, part of the coagulant coating 520 may be removed by dipping the uncured layer disposed on the former 504 into tank 546, which has an aqueous solution therein. As before, removing some of the coagulant coating 520 results in a thinner, subsequent layer of polymeric coating. The former 504 is then delivered to a tank 556 containing a foamed polymeric composition 548, which is disposed as an uncured foamed polymeric layer 558 on the uncured unfoamed polymeric layer 512 discussed above. The former 504 is then optionally rotated around a horizontal axis to remove some of the uncured foamed polymeric layer 558. Also, optionally, the former 504 is dipped into a water tank, such as tank 546 to remove some of the uncured foamed polymeric layer 558. The former 504 is then delivered to an oven 560, wherein the uncured foamed polymeric layer 548 and uncured unfoamed polymeric layer 512 are cured with heat, as discussed above, to form a glove 550. The curing can be accomplished in two or more stages of varied temperatures and/or time periods, as discussed above. The glove 550 is then stripped from the former 504, and is optionally inverted, i.e., turned inside out. Accordingly, the glove 550 may be worn with the foamed layer on an inside or an outside of the glove 550.

Embodiments of at least one method of manufacturing a polymeric article, according to embodiments of the invention, comprise disposing a coagulant on a former, the former having at least two regions; dipping the coagulant coated former into a non-foamed polymeric, elastomeric, or latex coating composition, thereby forming a non-foamed polymeric, elastomeric, or latex coating on the at least two regions of the former; disposing a coagulant on the non-foamed polymeric, elastomeric, or latex coating disposed on the at least two regions of the former, forming a coagulant layer on the non-foamed polymeric, elastomeric, or latex coating; dipping the coagulant coated non-foamed polymeric coating into a foamed polymeric composition, forming a foamed coating on the non-foamed polymeric, elastomeric, or latex coating; washing the foamed coating disposed on the non-foamed polymeric, elastomeric, or latex coating in water; wherein the washing step partially removes the foamed coating; and curing the non-foamed polymeric, elastomeric, or latex coating and the foamed coating in at least two steps.

Optionally, methods according to embodiments of the invention include wherein the at least two steps includes a first curing step by heating the non-foamed polymeric, elastomeric, or latex coating and the foamed coating at a first temperature and a second curing step at a second temperature, wherein the second temperature is higher than the first temperature. Furthermore, optionally, methods include wherein the first curing step includes heating the non-foamed polymeric, elastomeric, or latex coating and the foamed coating at 50-90° C. for 5-10 minutes and the second curing step includes heating the non-foamed polymeric, elastomeric, or latex coating and the foamed coating at 90-160° C. for 20 to 90 minutes.

As discussed above, there are at least two process steps to lessen the thickness of a polymeric layer disposed on a polymeric article as compared with other regions (such as, for a glove, the tips of a finger/thumb, an entire finger/thumb, an upper palm region, a lower palm region, a cuff, and the like) of a polymeric article, according to embodiments of the invention, irrespective of whether a polymeric layer is foamed or non-foamed. Any embodiment of the invention can include or exclude either one or both of these process steps. First, after the application of a coagulant on a former or on a fabric liner, some or all of the coagulant can be removed, for example, by washing. The partial or total removal of the coagulant from the former or liner, corresponding to a region of, for example, a glove, will result in a thinner polymeric layer at that region. Second, after the disposition of a polymeric layer or gelled composition layer, a leaching step in a liquid, such as water or an aqueous solution, at known temperatures for known durations, can remove portions of the polymeric layer or gelled composition layer, resulting in thinner layers. Leaching can be performed in any region of the polymeric article. Also, embodiments of the invention optionally comprise methods to reduce the thickness of the foamed coating such as an air knife or a heat treatment as are known to those in the art.

Although only a few exemplary embodiments of the present invention have been described in detail above, those skilled in the art will readily appreciate that many modifications are possible in the exemplary embodiments without materially departing from the novel teachings and advantages of this invention.

All ranges recited herein include ranges therebetween, and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4 . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4 or more, or 3.1 or more.

Any embodiment described herein that can logically be combined with another described herein, such that a person of ordinary skill would recognize that they can desirably be combined, are contemplated to be within the invention. For example, any ratio of thicknesses of the foamed layer described here is applicable to all embodiments having an unfoamed and a foamed layer.

Publications and references, including but not limited to patents and patent applications, cited in this specification are herein incorporated by reference in their entirety and cited as if each individual publication or reference were specifically and individually indicated to be incorporated by reference herein as being fully set forth.

The foregoing description of embodiments of the invention comprises a number of elements, devices, machines, components and/or assemblies that perform various functions as described. These elements, devices, machines, components and/or assemblies are exemplary implementations of means for performing their respectively described functions. While the foregoing is directed to embodiments of the present invention, other and further embodiments of the invention may be devised without departing from the basic scope thereof.

What is claimed is:

1. A polymeric article, comprising:
an outer polymeric layer of a non-foamed polymeric composition, comprising:
at least one of synthetic rubber, natural rubber, polyisoprene, polyurethane, nitriles, carboxylated-nitriles, polychloroprene, a thermoplastic elastomer, or blends thereof;
an inner foamed layer of a second polymeric composition disposed on the outer polymeric layer, comprising:
at least one of synthetic rubber, natural rubber, polyisoprene, polyurethane, nitriles, carboxylated-nitriles, polychloroprene, a thermoplastic elastomer, or blends thereof and further comprising at least one acrylic emulsion thickener;
at least one accelerator,
at least one anionic surfactant; and
at least one thixotropic agent, wherein the outer polymeric layer is thicker than the inner foamed layer.

2. The polymeric article of claim 1, wherein at least one of the non-foamed polymeric composition or the second polymeric composition is free from diphenyl guanidine.

3. The polymeric article of claim 1, wherein at least one of the non-foamed polymeric composition or the second polymeric composition comprises approximately equal amounts of polyisoprene and polychloroprene.

4. The polymeric article of claim 1, wherein at least one of the non-foamed polymeric composition or the second polymeric composition includes a polysulphidic sulphur donor.

5. The polymeric article of claim 4, wherein the at least one polysulphidic sulphur donor is at least one of xanthogen polysulphide or dipentamethylene thiuramtetrasulfide.

6. The polymeric article of claim 1, wherein the at least one accelerator comprises a dithiocarbamate, a thiazole, or a long chain thiuram.

7. The polymeric article of claim 1, wherein the polymeric article is one of a surgical glove, an examination glove, a condom, a finger cot, or a sleeve.

8. The polymeric article of claim 1, wherein the inner foamed layer is an open-celled structure capable of absorbing moisture.

9. The polymeric article of claim 1, wherein the at least one accelerator comprises at least one of zinc dibutyl dithiocarbamate, zinc 2-mercaptobenzothiazole, N—N′-diphenylthiourea, dipentamethylene thiuramtetrasulfide, zinc diethyl dithiocarbamate, or sodium dibutyl dithiocarbamate.

10. The polymeric article of claim 7, wherein the surgical glove or examination glove comprises a palm area, a backhand area, an index finger, a middle finger, a ring finger, a little finger, and a thumb, wherein the inner foamed layer is disposed on at least one of the index finger, middle finger, ring finger, little finger, and thumb and is thinner than a second foamed layer disposed on at least one of the palm area, backhand area, index finger, middle finger, ring finger, little finger, and thumb.

11. The polymeric article of claim 10, wherein a thickness of at least one of the inner foamed layer or the second foamed layer is approximately 20%-50% of the thickness of the surgical or the examination glove.

12. A method of manufacturing a polymeric article, comprising:
disposing a coagulant on a former, the former having at least two regions;
dipping the coagulant coated former into an unfoamed polymeric, elastomeric, or latex coating composition, thereby forming a non-foamed polymeric, elastomeric, or latex coating on the at least two regions of the former;
disposing a coagulant on the non-foamed polymeric, elastomeric, or latex coating disposed on the at least two regions of the former, forming a coagulant layer on the polymeric, elastomeric, or latex coating;
partially removing the coagulant layer from at least one region of the non-foamed polymeric, elastomeric, or latex coating;
dipping the coagulant coated non-foamed polymeric coating into a foamed polymeric composition, forming a foamed coating on the polymeric, elastomeric, or latex coating; and
curing the non-foamed polymeric, elastomeric, or latex coating and the foamed coating, forming a polymeric article wherein the polymeric article is thinner in the at least one region having the coagulant layer partially removed.

13. The method of claim 12, wherein the polymeric article is one of a surgical glove, an examination glove, a condom, a finger cot, or a sleeve.

14. The method of claim 12, optionally comprising a washing step following the dipping the coagulant coated polymeric coating step for reducing the thickness of the foamed coating.

15. The method of claim 12, optionally comprising an air knifing or a heat treating step for reducing the thickness of the foamed coating.

16. The method of claim 12, further comprising a step for at least one of sterilizing the glove or reducing a tackiness of the polymeric article.

17. The method of claim 13, further comprising disposing additional coagulant on the non-foamed polymeric, elastomeric, or latex coating on a backhand area of the surgical glove or examination glove, wherein an even coagulant layer on the non-foamed polymeric, elastomeric, or latex coating is formed.

18. A method of manufacturing a polymeric article, comprising:
disposing a coagulant on a former, the former having at least two regions;
dipping the coagulant coated former into a non-foamed polymeric, elastomeric, or latex coating composition, thereby forming a non-foamed polymeric, elastomeric, or latex coating on the at least two regions of the former;
disposing a coagulant on the non-foamed polymeric, elastomeric, or latex coating disposed on the at least two regions of the former, forming a coagulant layer on the non-foamed polymeric, elastomeric, or latex coating;
dipping the coagulant coated non-foamed polymeric coating into a foamed polymeric composition, forming a foamed coating on the non-foamed polymeric, elastomeric, or latex coating;
washing the foamed coating disposed on the non-foamed polymeric, elastomeric, or latex coating in water; wherein the washing step partially removes the foamed coating; and
curing the non-foamed polymeric, elastomeric, or latex coating and the foamed coating in at least two steps.

19. The method of claim 18, wherein the at least two steps includes a first curing step by heating the non-foamed polymeric, elastomeric, or latex coating and the foamed coating at a first temperature and a second curing step at a second temperature, wherein the second temperature is higher than the first temperature.

20. The method of claim 18, wherein the first curing step includes heating the non-foamed polymeric, elastomeric, or latex coating and the foamed coating at 50-90° C. for 5-10 minutes and the second curing step includes heating the non-foamed polymeric, elastomeric, or latex coating and the foamed coating at 90-160° C. for 20 to 90 minutes.
